(19) United States
(12) Patent Application Publication
(10) Pub. No.: US 2012/0215753 A1
(43) Pub. Date: Aug. 23, 2012

(54) REAL-TIME PROFESSIONAL SERVICES MOBILE APPLICATION SYSTEM, METHOD, AND STORAGE MEDIUM

(75) Inventor: Aleisha Gravit, Great Falls, VA (US)

(73) Assignee: Gravit Consulting, LLC, Austin, TX (US)

(21) Appl. No.: 13/401,778

(22) Filed: Feb. 21, 2012

Related U.S. Application Data
(60) Provisional application No. 61/444,765, filed on Feb. 20, 2011.

(51) Int. Cl. G06F 17/30

(52) U.S. Cl. 707/705; 707/E17.001

(57) ABSTRACT

A mobile application providing access to data stored within the content management system of a company.

### CROSS-REFERENCE TO RELATED APPLICATIONS

This application claims the benefit of provisional patent application 61/444,765 filed on Feb. 20, 2011, which is hereby incorporated by reference in its entirety.

### FIELD OF THE INVENTION

This disclosure relates generally to the field of sales and business development mobile applications and more specifically to the field of sales and business development mobile applications for professional services and product sales.

### BACKGROUND OF THE INVENTION

Mobile applications provide functionality available to users over handheld devices, such as smartphones or PDAs. And for many users, particularly those in the fields of sales or legal services, having specific information readily available during a client interaction is critical.

### SUMMARY

A mobile application providing access to data stored within the content management system of a company.

### BRIEF DESCRIPTION OF THE DRAWINGS

The features, natures, and advantages of the disclosed subject matter may become more apparent from the detailed description set forth below when taken in conjunction with the drawings in which like reference characters identify correspondingly throughout and wherein:

FIG. 1 is a process flow depicting how a user may engage the disclosed application through a security feature;

FIG. 2 depicts an example of an application icon which provides access to the application;

FIG. 3 depicts an example of feature icons displayed on the user interface;

FIG. 4A is a high level representation of the organizational structure of client information provided by the application;

FIG. 4B is a process flow showing how a user may find a particular client;

FIGS. 4C-4E depict screenshots of the graphical user interface of the application showing representative clients;

FIG. 5 is a representation of a screenshot of an interface showing specific and detailed information about a particular client;

FIG. 6A is a flow chart representing the organization and selection options;

FIGS. 6B-6D are representative of screen shots showing the graphical user interface;

FIG. 7A is a flow chart representing the organization and selection options;

FIG. 7B is representative of a screenshot of a graphical user interface;

FIG. 8 is a series of screen shot representations;

FIG. 9A is a flow chart representing the organization and selection options;

FIG. 9B is a screen shot representation; and

FIG. 10 is a screen shot representation.

### DESCRIPTION OF THE SPECIFIC EMBODIMENTS

The following description is not to be taken in a limiting sense, but is made for the purpose of describing the general principles of the present disclosure. The scope of the present disclosure should be determined with reference to the claims. And although described with reference to the targeted distribution of a mobile advertisement over a mobile network, a person skilled in the art could apply the principles discussed herein to various networks and various forms of mobile advertisements.

Preferred embodiments of the present disclosure are illustrated in the drawings, like numbers being used to refer to like and corresponding parts of the various drawings.

In accordance with the present disclosure, a mobile application is presented which provides secure access to data and information thereby offering a competitive advantage in a sales situation. And although described with reference to the legal industry, various embodiments of the disclosed subject matter may be applied to any field requiring company specific data in real time—such as accounting firms. Other systems, methods, features, and advantages here provided will become apparent to one with skill in the art upon examination of the following Figures and description.

The following disclosure relates to a mobile application that provides secure access to data and information that is already collected and stored, within a company or organization's document management or content management system, which may be used for the purpose of driving sales and business development efforts. The mobile application disclosed provides a distinct competitive advantage by having limited, yet critical information that is needed to increase sales and business development efforts ‘at the ready’ to convey to potential clients.

The disclosed subject matter may allow a business, such as a law firm, to gain a competitive edge over another through the use of a client-facing application. A primary benefit of the mobile application would be its use by lawyers to drive business development by lawyers. However, this disclosure provides much more than a useful mobile application for lawyers; it is a mobile application that may be used to drive sales and increase revenue across many industries.

Most law firms have a sophisticated document/content management system (DMS/CMS) as well as some type of client relationship management system (CRM). Further, it is highly likely that most law firms also have some type of experience database and proposal preparation system that stores information such as: descriptions of each practice within the firm, examples of successful litigation matters, representative client lists, examples of deals done by the firm—to name a few categories of firm information. Additionally, the client relationship management system may have the ability to track the following information at the client level: who knows whom, opportunities at the client level, activities done with the client such as invitations to events, dinners, etc.

Often, each time a lawyer receives an RFP or is asked to submit materials on experience in a particular area, the marketing department or another designated individual of that firm consults with the lawyer and either prepares new material or utilizes content that may be previously stored in the firm's DMS/CMS and CRM systems. This usually results in either a PDF or a printed set of materials the firm uses for marketing purposes and often is made available to the public on the firm's website. In order to develop new business and expand existing business, lawyers may need to use this type of information. However, other types of confidential information may be needed that is not publicly available for the purposes of business development.

In the world of sales and business development, time is of the essence. There are often limited windows of opportunity when a sale can be closed quickly and effectively by having the right information at the right time. The amount of time it takes one person to meet with a client and return to the office or make a call to obtain necessary information for the sale could result in a missed opportunity. One of the most significant non-financially related or motivated business development challenges for law firms (or any sales culture) is the need to readily arm the lawyers and/or advisors with current and accurate information about the firm's experience to enable them to sell the firm's services, regardless of the place, time or environment.

The present disclosure provides a mobile application that provides secure real-time access to data and information that is collected and stored within a company or organization's document management or content management system, and may be used for the purpose of obtaining a competitive position and ultimately closing a sale, thereby increasing revenue. For the purpose of this disclosure, Professional Services shall include law firms and accounting firms. However, the application disclosed is not limited to these services as this type of mobile application may be scaled to other verticals that employ a sales force to drive sales and increase revenue.

Because the disclosed the mobile application is fully customizable depending on need, each design/display will be different. Thus, the mobile application is completely customizable depending on the company or organization's sales or business development goals and strategies. Thus, the examples shown in the figures are merely representative of the types of information the mobile application may provide. And although the description and figures provided relate to the legal/Professional Services Industry, this mobile application may also be of use in the Energy/Oil & Gas/Oilfield Services and Pulp and Paper/Fine Paper Sales verticals for example.

The disclosed mobile application solves the problem of not having complete and/or competitive information ‘at the ready’ to facilitate closing a sale or to further an organizations business development strategies. The mobile application may be used on any smartphone, including the iPhone, iPad or any mobile device or Smartphone with similar functionalities. In order to accommodate certain types of smartphones, such as a Blackberry, the application would be developed as a “movi”. Since the content needed to make mobile application useful will be stored on the company or organization's server, for security purposes the company or organization will deliver the mobile application to users along with a secure id that is needed to access the data behind the mobile application.

The disclosed mobile application provides critical information ‘at the ready’ to close a sale or to further business development strategies. This information includes, but is not limited to:

Legal Industry—non-traditional sales environment
Representative clients (identifiable by industry, geography, type of work handled)
For transactional practices, experience may include, but is not limited to:
   Deal flow and value
      Value
      By deal type
         M&A
         144A
         Finance
         Etc
For litigation/advocacy practices, it may include, but is not limited to:
   Experience
      By type of litigation
      By Court
      By result type
         Verdict amount
         Summary judgment
         Settlement
         Arbitration
         Etc.
Talking Points—“FastInfo”
   Brief bullets that describe what differentiates the practice from competitors and provides other brief facts
News feed—ability to input client names to track via RSS feed
Cross-development—“xSell”—links to other practices that contain it or like information needed to effectively sell the practice.
   Traditional Sales Environment—depends on industry and need. The following industry examples are described for illustrative purposes.
   Pulp and Paper—fine paper sales
Inventory by Mill
   Brands
   Colors
   Sizes
   Basis weight
   Finish
   Manufacturing minimum
Local Inventory
   Brand
   Size
   Color
   Basis weight
   Finish
   Amount in stock
   Amount on order
   Due to arrive
Shipping Schedule By Mill and by Brand

### Energy—Oil & Gas—Oilfield Services

Well Data
   Drill type
      Straight
      Horizontal
      Directional
   Location
   Target Sand
   Target Formation
Service Line (customizable by company offerings)
Company Experience
   Engineer
      Number of wells
   Drilling methods

The following description and figures are used to show both the functionality and operation of the disclosed mobile application and various graphical interface display capabilities.

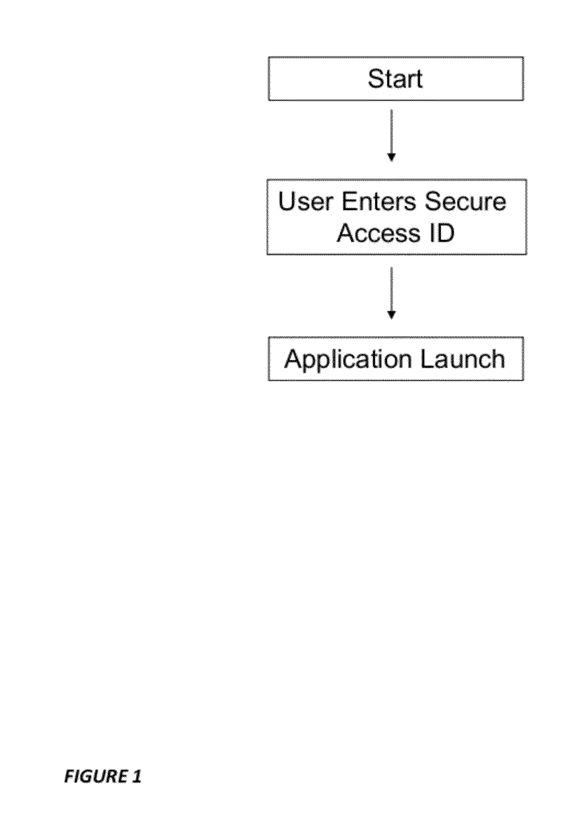

FIG. 1 is a process flow depicting how a user may engage the disclosed application through a security feature. The security feature provides a mechanism to ensure confidential information may only be access by lawyers or employees of the firm. First, the user may be required to enter a secure ID in order to gain access to the confidential information provided by the application. Once the user is authenticated, the mobile application launches.

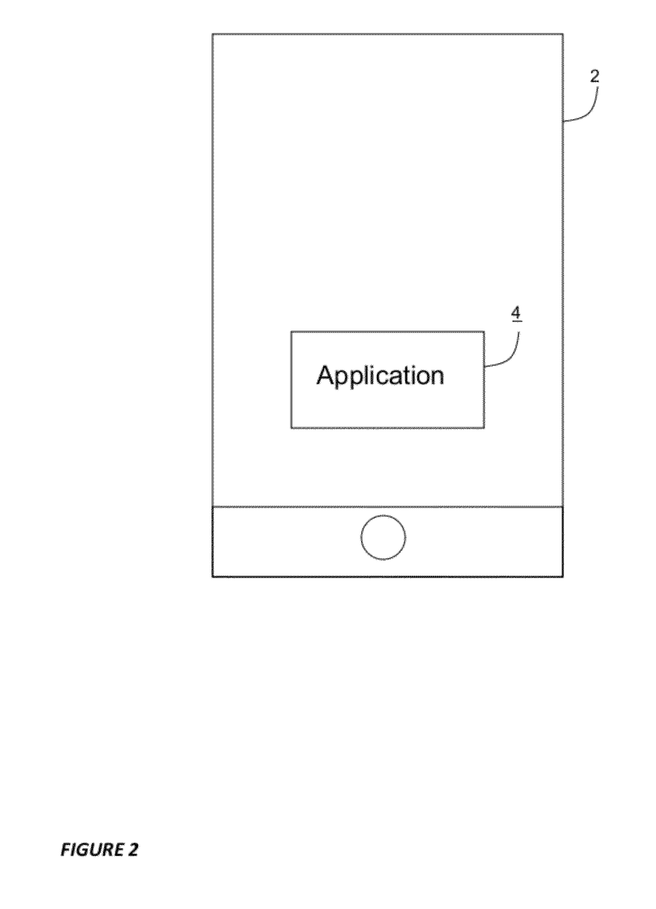

FIG. 2 depicts an example of an application icon which provides access to the application, shown as icon 4, displayed in the graphical user interface of smartphone 2.

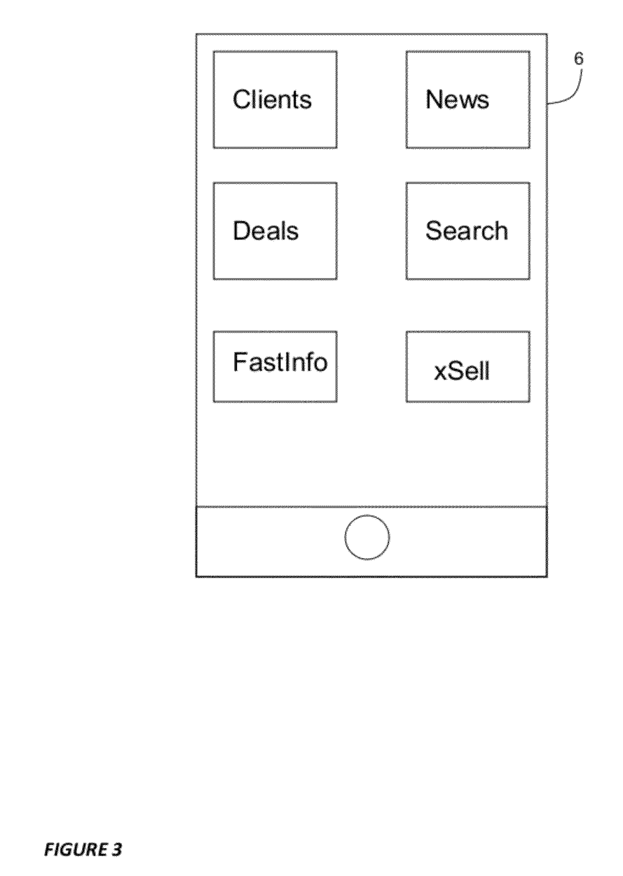

FIG. 3 depicts an example of feature icons displayed on the user interface of smartphone 6 which provide access to examples of various functionalities of the application—these icons are fully customizable. The feature icons shown in FIG. 3 relate to legal/professional services which would provide advantageous information for a potential transactional/corporate services client. As an example, the user may select: the Clients icon to retrieve information about current firm clients, the News icon to retrieve news about current firm clients; the Deals icon to retrieve information concerning deals the firm has worked on; the Search icon to search for information by key word; the xSell icon to retrieve information related to the specific firm practices and services; or the FastInfo icon to retrieve talking points and firm differentiators and other competitive information to use when talking with a client or potential client.

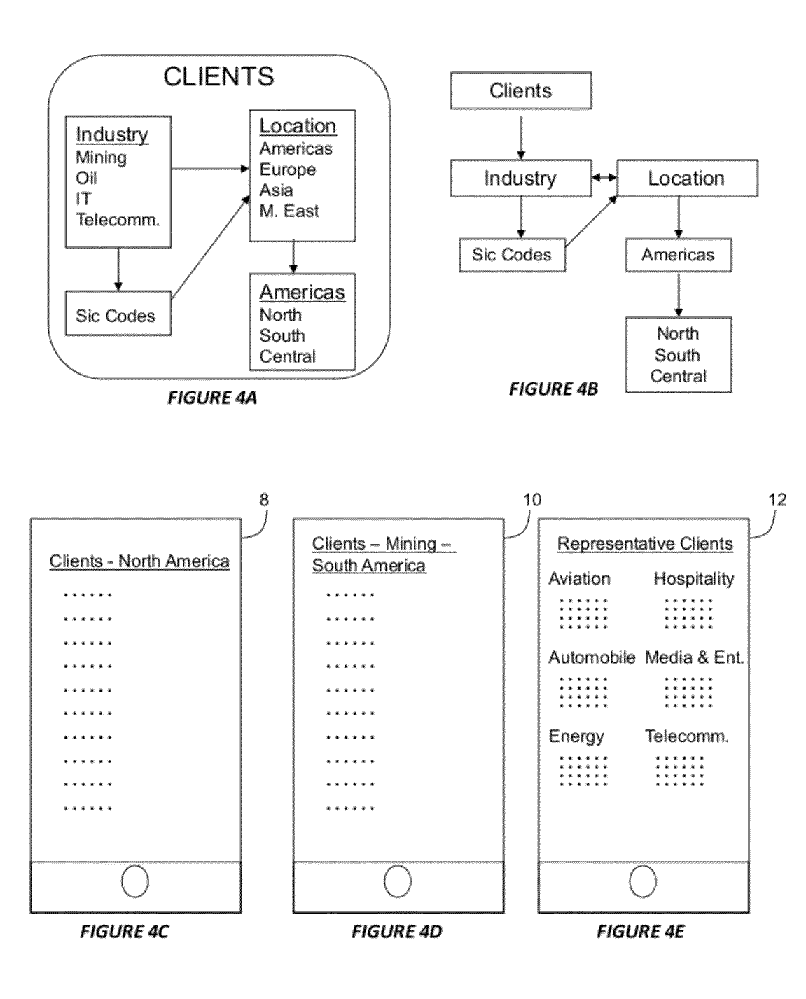

The disclosed application provides a variety of information to the user based on selections the user makes—thus the user is able to find the information needed for the development of a particular client. FIG. 4A is a high level representation of the organizational structure of client information provided by the application and presented to the user to enable the quick and easy selection of a specific list of current firm clients. FIG. 4B is a process flow showing how a user may find a particular client—by first selecting the Client icon in FIG. 3, then sorting through the search options shown in FIG. 4B.

FIGS. 4C-4E depict screenshots of the graphical user interface of the application showing representative clients based on criteria that the user has selected. FIG. 4C depicts an example of a user interface showing a client list selected by geography, the firm's North American Clients, displayed on smartphone 8. The application may pull these particular clients from the CMS system based on postal codes. FIG. 4D depicts an example of a user interface showing a client list selected by industry and geography, the firm's South American Mining clients, displayed on smartphone 10. FIG. 4E depicts an example of a user interface showing a representative client list organized by industry, the industries displayed are shown as an example, displayed on smartphone 12. The application may pull these particular clients from a combination of firm records and the CMS system. Thus, the application allows the user to identify representative clients based on various criteria.

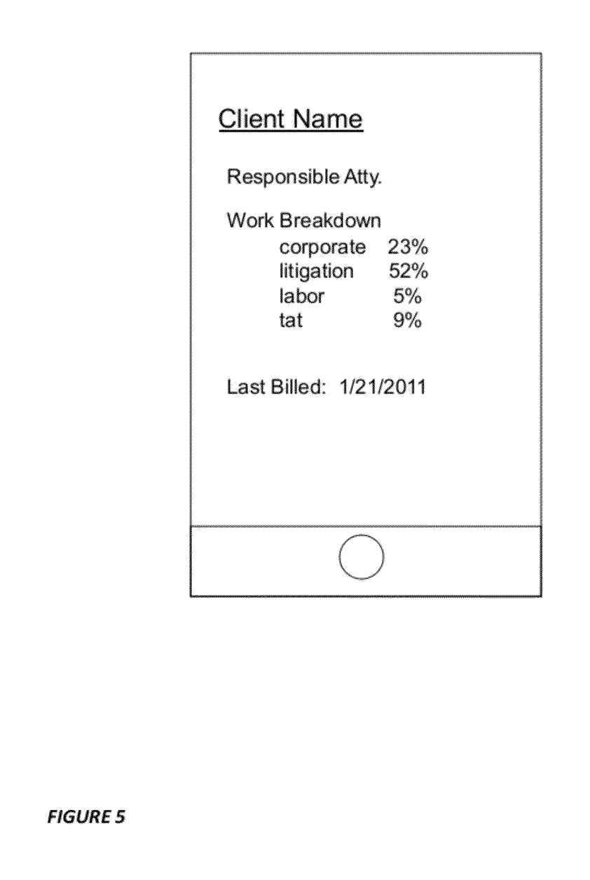

FIG. 5 is a representation of a screenshot of an interface showing specific and detailed information about a particular client—here the user has selected or searched for a client name. The responsible attorney listed may be based on firm protocol (i.e. a partner level atty.). The work breakdown and billing date data is pulled from CMS or from a custom database template.

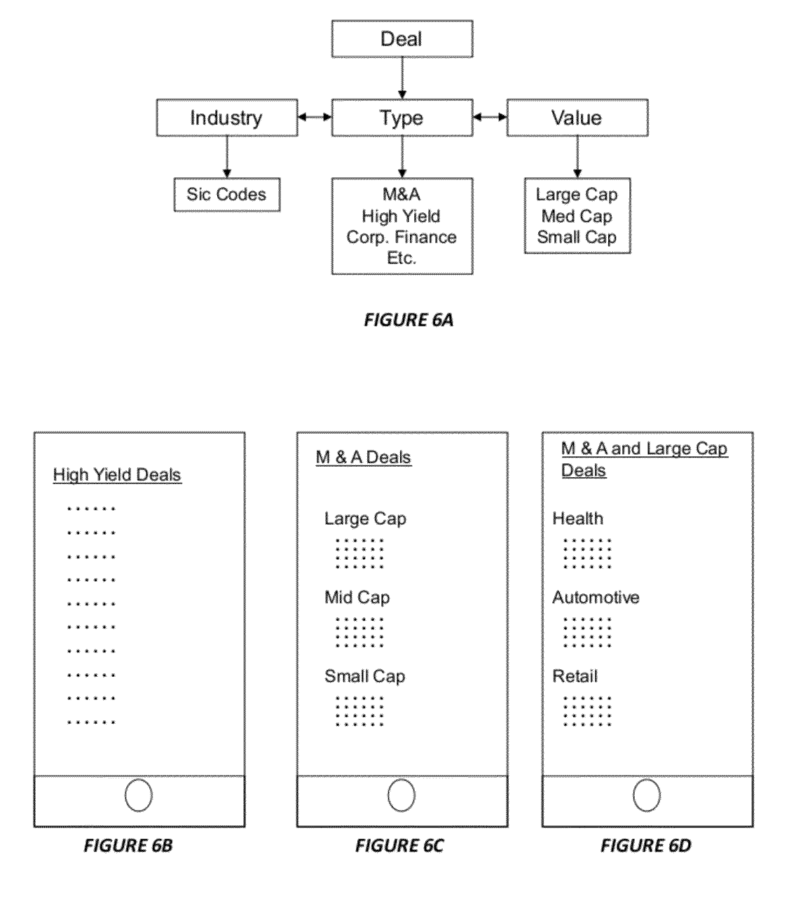

FIG. 6A is a flow chart representing the organization and selection options presented to a user to select firm deal related data. For example, deals may be selected by type of deal (which depends on the type of work done by the firm), industry of the deal, or value (value criteria may be customizable by the firm itself). FIGS. 6B-6D are representative of screen shots showing the graphical user interface displaying deals selected by the user.

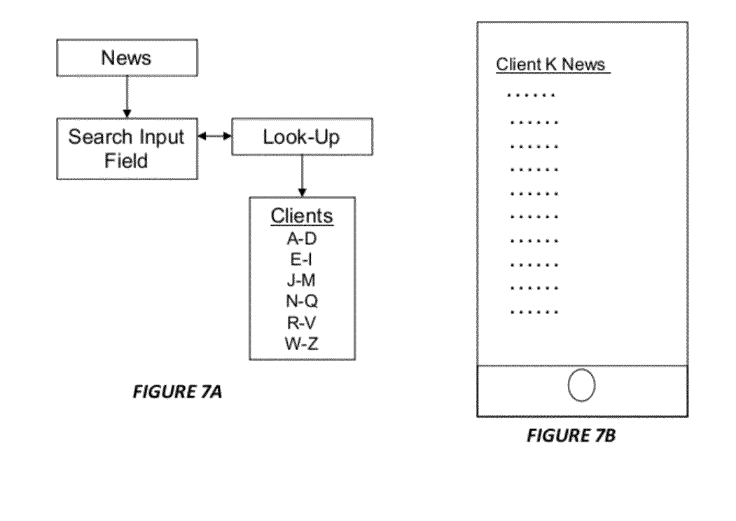

FIG. 7A is a flow chart representing the organization and selection options presented to a user to select recent news related data. The user may select or use a keyword search to find news from a predefined news aggregate or database about a particular firm client. FIG. 7B is representative of a screenshot of a graphical user interface showing client news related data provided by the application.

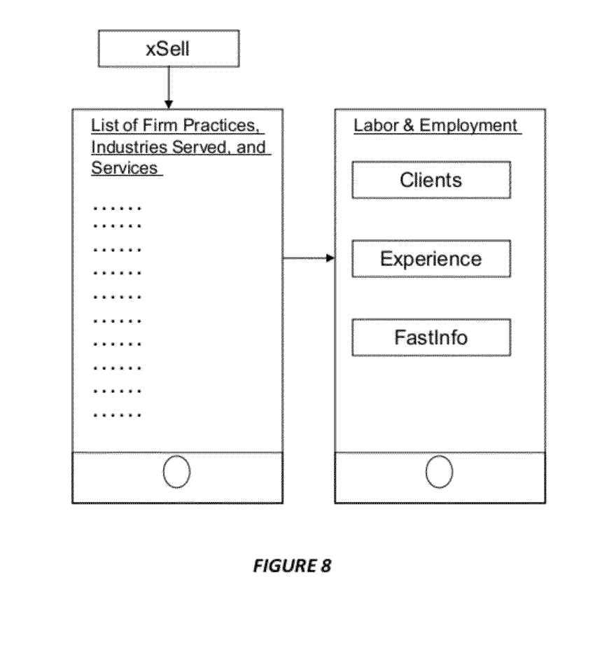

FIG. 8 is a series of screen shot representations for Cross Development (xSell) purposes that presents selection options and data provided to the user by the application. If the user selects Practices from the example screen provided in FIG. 3, they are provided with a list of the firm's practice areas, industries served, and services provided. The user may then select an appropriate practice and is provided with client development information related to that practice—shown in FIG. 8 as Labor & Employment. The client may then choose to see, for example, more information related to the firms clients in that practice areas, the firms experience in that practice area, or predefined talking points related to that practice area. These options are fully customizable based on the firms systems and requirements.

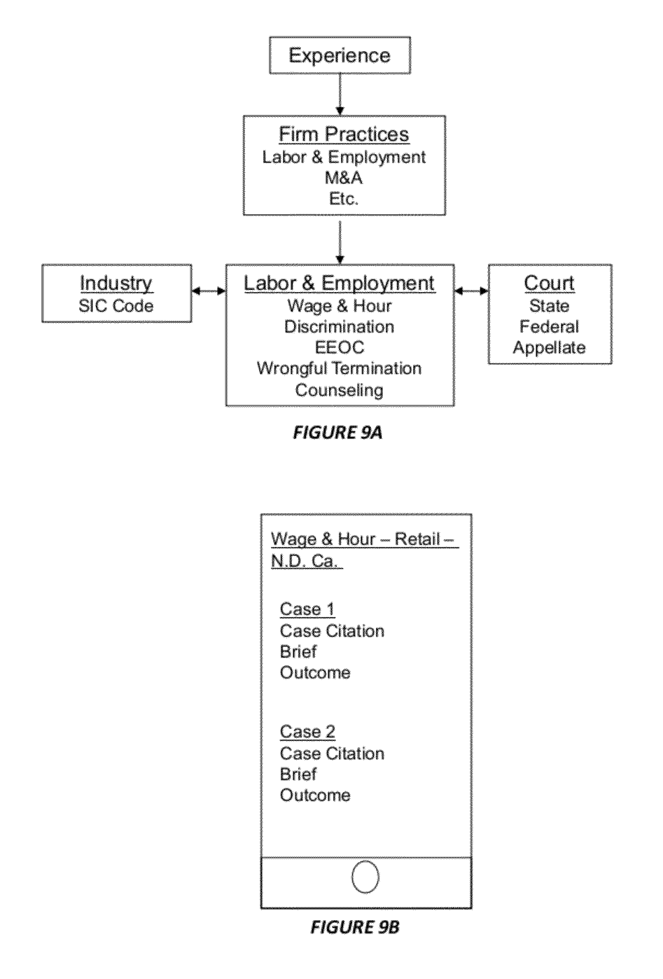

FIG. 9A is a flow chart representing the organization and selection options presented to a user to select recent firm experience related data, as shown in FIG. 9A the user has selected information relating to Labor & Employment. The selection criteria and information shown is customizable by firm practice—thus the Bankruptcy practice will have different selection options than that of Labor & Employment. FIG. 9B is a screen shot representation showing information relating to a firms experience in Wage & Hour related cases for Retail clients in the Northern District of California.

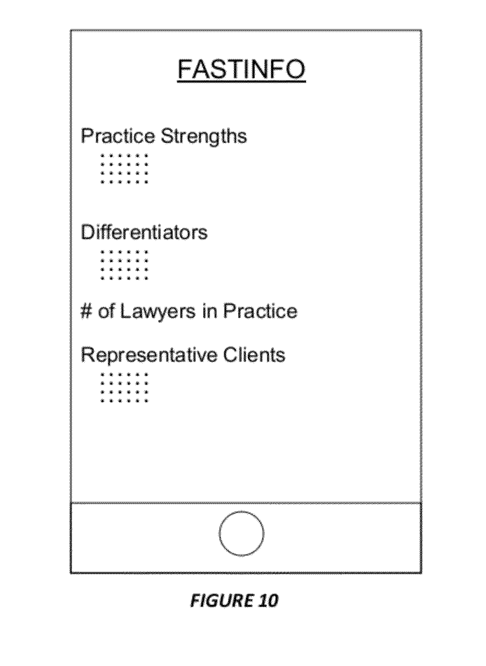

FIG. 10 is a screen shot representation showing predetermined talking points (FastInfo) for the user to use in client development. The talking points screen may be a fully customizable template providing information the firm deems most pertinent to client development for the specific practice.

The foregoing description of the preferred embodiments is provided to enable any person skilled in the art to make or use the disclosed subject matter. Various modifications to these embodiments will be readily apparent to those skilled in the art, and the generic principles defined herein may be applied to other embodiments without the use of the innovative faculty. Thus, the subject matter is not intended to be limited to the embodiments shown herein but is to be accorded the widest scope consistent with the principles and novel features disclosed herein.

1. A mobile application, comprising:
a downloadable software program providing access to data stored within the content management system of a company.
